(19) United States
(12) Patent Application Publication
(10) Pub. No.: US 2026/0244167 A1
(43) Pub. Date: Aug. 20, 2026

(54) METHODS AND SYSTEMS FOR FOAMING EVENTS PREDICTION IN GAS PLANTS

(71) Applicant: SAUDI ARABIAN OIL COMPANY, Dhahran (SA)

(72) Inventors: Mona Alshahrani, Thuwal (SA); Fatima Al Alobaidi, Thuwal (SA); Muntaha Jaber, Thuwal (SA); Mohammed Alruwaii, Fadhili (SA); Hassane Trigui, Jeddash (SA)

(73) Assignee: SAUDI ARABIAN OIL COMPANY, Dhahran (SA)

(21) Appl. No.: 19/055,363

(22) Filed: Feb. 17, 2025

(51) Int. Cl. G05B 13/02

(52) U.S. Cl. CPC G05B 13/027

(57) ABSTRACT

A method for predicting foaming in a gas processing plant including acquiring process data and laboratory data, fusing the process data and laboratory data, predicting a foaming event, and injecting an anti-foaming agent based on the predicted foaming event. A system for predicting foaming, including a gas processing plant and a computer with computer processors coupled to sensors. The gas processing plant includes an absorber, a regenerator, and sensors. The computer is configured to acquire process data and laboratory data, fuse the process data and laboratory data, determine a foaming event, and transmit a signal to inject an anti-foaming agent based on the foaming event. A non-transitory computer-readable memory including computer-executable instructions that cause a processor to acquire process data and laboratory data, fuse the process data and laboratory data, determine a foaming event, and transmit a signal to inject an anti-foaming agent based on the foaming event.

### BACKGROUND

Gas sweetening processes conducted in gas processing plants remove impurities such as carbon dioxide and hydrogen sulfide from natural gas. In gas sweetening processes, foaming may occur, potentially resulting in reduced efficiency, increased energy consumption, carbon dioxide emissions, and solvent losses. Accordingly, there exists a need for a model that can continuously monitor and preemptively predict foaming events to ensure preventative measures are taken to avoid the foaming event altogether, thus improving efficiency of the gas processing plant.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for predicting foaming in a gas processing plant. In the method, process data is acquired, using sensors disposed in the gas processing plant, at a process sampling frequency. Laboratory data is acquired from samples acquired from the gas processing plant at a laboratory sampling frequency. The process data at the process sampling frequency and laboratory data at the laboratory sampling frequency are fused to produce a synchronized data set at a synchronized sampling frequency. A foaming event is predicted, using a machine learning model, based on the synchronized data set. An anti-foaming agent is injected into the gas processing plant based on the predicted foaming event.

In another aspect, embodiments disclosed herein relate to a system for predicting foaming in gas processing plants including a gas processing plant and a computer containing computer processors. The gas processing plant includes an absorber, a regenerator, and sensors. The absorber receives a sour gas feed and a lean solvent to produce a rich solvent and a sweet gas. The regenerator receives the rich solvent and produces the lean solvent to circulate back to the absorber for continual processing. The sensors are disposed on the gas processing plant. The computer containing computer processors is communicably coupled to the sensors. The computer is configured to acquire process data at a process sampling frequency from the sensors and acquire laboratory data at a laboratory sampling frequency using samples acquired from the gas processing plant. The computer fuses the process data and the laboratory data to produce a synchronized data set at a synchronized sampling frequency. The computer determines, using a machine learning model, a foaming event based on the synchronized data set. The computer transmits a signal to inject an anti-foaming agent based on the foaming event.

In another aspect, embodiments disclosed herein relate to a non-transitory computer-readable memory including computer-executable instructions stored that, when executed on a processor, cause the processor to perform several steps. Initially, process data is acquired at a process sampling frequency from sensors disposed on a gas processing plant. Laboratory data is acquired at a laboratory sampling frequency from samples acquired from the gas processing plant. Process data and laboratory data is used to produce a synchronized data set at a synchronized sampling frequency. A foaming event is determined, using a machine learning model, based on the synchronized data set. A signal is transmitted to an anti-foaming injector to inject an anti-foaming agent based on the foaming event, resulting in the anti-foaming injector injecting the anti-foaming agent when the signal is transmitted.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a gas processing plant in accordance with one or more embodiments.

FIG. 2 depicts a block diagram in accordance with one or more embodiments.

FIG. 3 depicts a block diagram in accordance with one or more embodiments.

FIG. 4 illustrates a neural network in accordance with one or more embodiments.

FIG. 5 depicts a flow chart in accordance with one or more embodiments.

FIG. 6 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “sensor” may include any number of “sensors” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

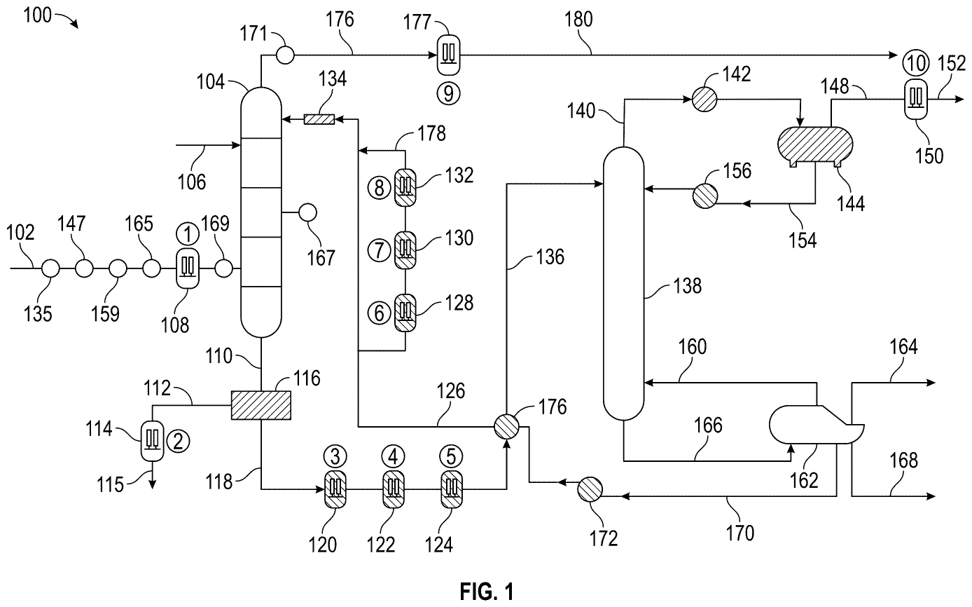

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to a method for predicting foaming in a gas processing plant. The gas processing plant is a gas sweetening process for removing impurities from natural gas. The method for predicting foaming utilizes a machine learning model to predict a foaming event based on both process and laboratory data to initiate injecting an anti-foaming agent into the gas processing plant.

In another aspect, embodiments disclosed herein relate to a system for predicting foaming in gas processing plants including an absorber, a regenerator, sensors, and a computer. The absorber produces a rich solvent and a sweet gas. The regenerator receives the rich solvent and produces lean solvent to circulate back to the absorber for continual processing. A computer included in the system acquires the process and laboratory data, fuses the process and laboratory data, and provides the fused data to a machine learning model to predict a foaming event and thus initiate the injection of an anti-foaming agent based on the foaming event.

In another aspect, embodiments disclosed herein relate to a non-transitory computer-readable memory with computer-executable instructions stored on that direct a processor to perform specific steps including acquiring the process and laboratory data to fuse and subsequently provide to a machine learning model to predict a foaming event and thus initiate the injection of an anti-foaming agent based on the foaming event.

FIG. 1 depicts the gas processing plant 100. A sour gas feed 102 initially flows through a gas liquid coalescer 108 to remove liquid contaminants from the sour gas feed 102 before being fed to the absorber 104. Throughout the gas processing plant 100, several gas liquid coalescers are used, each of which acts as a separator to remove liquid from a gas. In one or more embodiments, an additional make-up water feed 106 may be added to the absorber 104 to improve efficiency of the separation. Cooled lean amine solvent 126 is fed to a cooler 134 for further cooling before being fed to the absorber 104. Within the absorber 104, the lean amine solvent 126 removes contaminants from the sour gas feed 102, producing a wet sweet gas 176 and a rich amine solvent 110. The wet sweet gas 176 is provided to a gas liquid coalescer 177 to remove liquid contaminants, producing a sweet gas 180. The rich amine solvent 110 produced from the absorber 104 is provided to a flash tank 116 to remove flash gas 112 from the rich amine solvent 110. The flash gas 112 is passed through a gas liquid coalescer 114 to remove any liquid contaminants. In one or more embodiments, the flash gas 112 may contain hydrocarbons. The rich amine solvent 118 exiting the flash tank 116 may be passed through a liquid particle filter 120, a carbon vessel 122, and a liquid particle filter 124.

Each of these units works in series to remove contaminants from the rich amine solvent 118 before it flows to the heat exchanger 176, providing a heated rich amine solvent 136 to the regenerator 138. The regenerator separates the acid contaminants 140 which flow through a condenser 142 and into a reflux drum 144. The reflux drum 144 collects condensate from the condenser 142 and returns liquid reflux 154 back to the regenerator column 138 through a reflux pump 156. The vapor of the acid contaminants stream exiting the condenser is separated in the reflux drum 144 to produce a wet acid gas 148. The wet acid gas 148 flows through a gas liquid coalescer 150, producing an acid gas 152. The regenerator 138 also contains a reboiler 162. The lean amine solvent 166 exits the bottom of the regenerator 138 and is fed to the reboiler 162. The reboiler separates a vapor stream 160 from the lean amine solvent 166, returning the vapor stream 160 back to the regenerator column 138. The lean amine solvent 170 exits the reboiler to circulate back to the absorber 104. The lean amine solvent 170 is pumped, using a lean amine pump 172 through the heat exchanger 176, producing a cooled lean amine solvent 126. The cooled lean amine solvent 126 may flow either directly to a cooler 134 or through a bypass line 178 allowing the cooled lean amine solvent 126 to pass through a series of vessels, including a liquid particle filter 128, a carbon vessel 130, and a secondary liquid particle filter 132. The cooled lean amine solvent 126 is further cooled in the cooler 134 before being fed to the absorber 104.

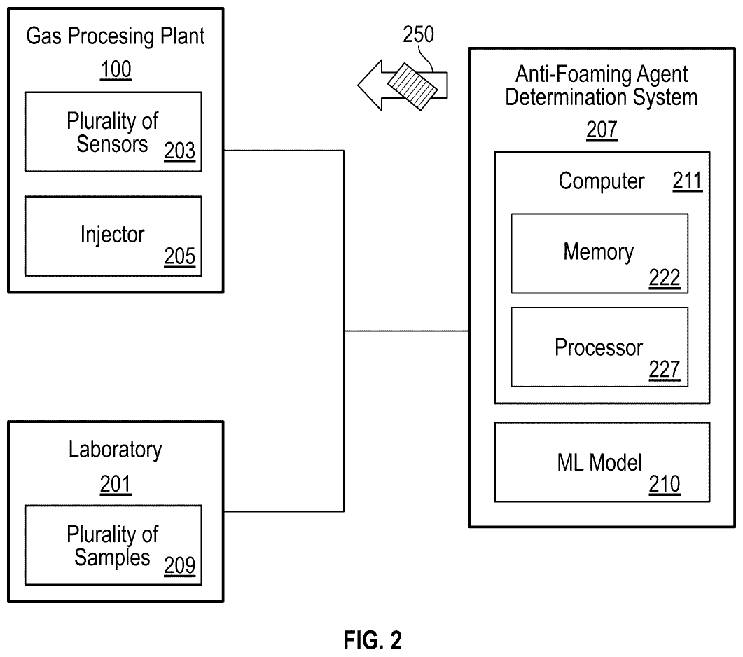

FIG. 2 depicts a block diagram of various hardware and/or system components connected to an anti-foaming agent determination system 207, in accordance with one or more embodiments. The anti-foaming agent determination system 207 includes, or is configured as, a computer 211 that operates to receive information from the gas processing plant 100 and the laboratory 201. The anti-foaming agent determination system further includes at least one machine learning model (“ML model 210”), where processes of the ML model 210 can be executed using the computer 211 or the anti-foaming agent determination system 207 itself. The received information from the gas processing plant 100 and the laboratory 201 is provided to and processed by the ML model 210 to predict a foaming event. In response to a predicted foaming event, the anti-foaming agent determination system 207 can cause an injection of an anti-foaming agent to the gas-processing plant 100. For example, the anti-foaming agent determination system 207 can issue a command (e.g., Command X 250) to the gas processing plant 100 and/or an anti-foaming agent injector (“injector”) 205 of the gas processing plant 100 to inject an anti-foaming agent into one or more processes of the gas-processing plant 100.

A variety of anti-foaming agents may be used, including silicon-based anti-foaming agents such as polydimethylsiloxane (PDMS) and silicon emulsions, both of which are highly effective at breaking down gas foaming under a wide range of operating conditions. Alternatively, polyalkylene glycol-based agents, such as ethylene oxide (EO) and ethylene propylene (EP) copolymers, may be used to provide strong foam suppression with low contamination risks. The anti-foaming agent may be selected based on process needs, solvent compatibility, and the foaming tendency of the system. In one or more embodiments, the injector 205 is located in one or more of several critical points, such as the absorber 104, flash tank 116, or the regenerator 138, to proactively address foaming issues. The anti-foaming agent system may be located in close proximity to the injection location. The anti-foaming agent system includes a storage tank of the anti-foaming agent, a mixer to avoid de-emulsifying of the anti-foaming agent, and injection pumps.

The gas processing plant 100 includes, in addition to the injector 205, a plurality of sensors 203. As described below, the plurality of sensors 203 are used to acquire data or measurement regarding processes or parameters of the gas-processing plant 100. For example, the plurality of sensors 203 can acquire temperature data and flow rate data proximate the location of respective sensors on the gas processing plant 100. Data or measurements obtained using the plurality of sensors, or sensor signals, are included in the aforementioned information that is received by the anti-foaming agent determination system 207 from the gas processing plant 100. In other words, the anti-foaming determination system 207 is used to predict a foaming event based on, at least in part, data, measurements, or signals acquired with the plurality of sensors 203. Further, a plurality of physical samples (“plurality of samples 209”) are acquired from the gas processing plant 100. For example, the plurality of samples 209 can include samples of gas extracted from predefined locations or processes of the gas processing plant 100. In some embodiments, extraction or acquisition of a sample in the plurality of samples is performed automatically using sampling equipment disposed on the gas processing plant 100. Sampling equipment can include a nozzle and a valve that diverts a portion of fluid conveyed by the gas processing plant to a container or test equipment. The plurality of samples 209 are processed at the laboratory 201. Information about the plurality of samples 209, e.g., gas composition, is provided to the anti-foaming agent determination system 207. Thus, the anti-foaming determination system 207 is used to predict a foaming event based on, at least in part, the plurality of samples 209.

The computer 211 includes a memory 222 and a processor 227. The processor 227 is formed by one or more processors, integrated circuits, microprocessors, or equivalent computing structures that serve to execute computer readable instructions stored on the memory 222. Thus, the memory 222 includes a non-transitory storage medium such as flash memory, a Hard Disk Drive (HDD), a solid state drive (SSD), a combination thereof, or equivalent storage devices. In relation to the invention as described herein, the memory 222 stores computer readable instructions, executed by the processor 227, that relate to one or more of: predicting a foaming event (e.g., executing the ML model 210); and controlling operations of the injector 205, where the predicted foaming event and control of the injector 205 are based on information gathered from the plurality of sensors 203 and the plurality of samples 209 from the laboratory 201. The plurality of sensors 203 and the plurality of samples 209 provide process data and laboratory data to, respectively, the anti-foaming agent determination system 207. As described below, the process data and laboratory data are fused together, e.g., using the computer 211, and processed, and processed using the ML model 210 to predict a foaming event based on the fused data.

The plurality of sensors 203 are present throughout the gas processing plant 100 to acquire process data. In one or more embodiments, the plurality of sensors 203 includes a temperature sensor, a sour gas feed sensor, and an absorber sensor.

The temperature sensor may be located within one or more of the absorber 104, the flash tank 116, and the regenerator 138, among other locations to monitor the temperature of critical points of the system which may impact the stability of foam and its formation and other system parameters. For example, a temperature sensor in the absorber 104 may monitor the temperature profile along the column trays, including the inlet and outlet gas streams as well as the amine solution within the absorber 104. Temperature monitoring of the absorber provides insight into the solubility of acid gases and hydrocarbons, the effectiveness of gas-liquid contact and chemical reactions, and the stability of the foam formation. Temperature monitoring of the flash tank 116 may be used to track the separation of entrained hydrocarbons or other impurities from the rich amine solution. Temperature monitoring of the regenerator 138 may be used to track the temperature gradient along the column and overhead condenser to ensure proper acid gas stripping and efficient amine regeneration, reducing the likelihood of foaming caused by incomplete regeneration and the release of acid gases.

The sour gas feed sensor may include a sour gas flow sensor 135, a sour gas feed pressure sensor 147, a sour gas feed temperature sensor 159, and/or a sour gas feed composition sensor 165. Each of these sour gas feed sensors monitor for different characteristics of the sour gas feed that may impact foaming events. The sour gas flow sensor 135 may be magnetic, ultrasonic, vortex, Coriolis, thermal dispersion type, differential pressure type, variable area, paddle type, turbine type, or a paddle wheel. The sour gas feed pressure sensor 147 may be a strain gauge, a piezoelectric sensor, capacitive, a manometer, a vacuum pressure sensor, a bourdon tube, or an aneroid barometer. The sour gas feed temperature sensor 159 may be a thermocouple, Resistance Temperature Detector (RTD), or a thermistor sensor. The sour gas feed composition sensor 165 may measure the concentration of specific components in the gas stream such as hydrocarbons, hydrogen sulfide, carbon dioxide, and other impurities. The sour gas feed composition sensor 165 may be a gas analyzer such as an infrared gas analyzer, gas chromatograph, or an electrochemical detector for real-time monitoring. Alternatively, a sample port (not shown) may be used to collect a sample and perform gas chromatography within a laboratory setting. The sour gas feed composition sensor 165 or sampling port may be located at key points to monitor gas composition including, but not limited to, at the gas liquid coalescer 108 outlet, the flash tank 116 outlet, the absorber 104 outlet, and/or around the reflux drum 144.

The absorber sensor may include an absorber pressure sensor (169, 171) and/or an absorber liquid level sensor 167. At least two absorber pressure sensors (169, 171) may be situated at two points within or surrounding the absorber to collect a differential pressure across the absorber that may be indicative of foaming events. Additionally, absorber pressure sensors may be located at intermediate sections (the trays of the absorber 104) to monitor pressure changes across the absorber 104 that may indicate signs of foaming or flooding or at the bottom of the absorber 104 to detect abnormal pressure buildup during the gas-liquid separation process (not shown). In one or more embodiments, the two absorber pressure sensors (169, 171) are located in the sour gas feed 102 and the wet sweet gas 176 line. Each of the absorber pressure sensors, the sour gas feed absorber pressure sensor 169 and the wet sweet gas pressure sensor 171, may be of the types listed above for the sour gas feed pressure sensor 147. The absorber liquid level sensor 167 measures the liquid level in the absorber to indicate if foaming is present or forming. The absorber liquid level sensor 167 may be a float level sensor, ultrasonic level sensor, waveguide type ultrasonic level sensor, capacitive sensor, diaphragm switch, submersible level sensor, or hole mounting fluid level sensor. In one or more embodiments, the absorber liquid level sensor 167 is located at the bottom of the absorber 104 where the rich amine collects after it has flowed down through the trays before exiting the absorber 104, in order to detect abnormal liquid accumulation.

The injector 205 is used to inject an anti-foaming agent in the gas processing plant 100. An anti-foaming agent determination system 207 can transmit a command (e.g., Command X 250) to the gas processing plant 100 or otherwise be considered a control system of the gas processing plant 100 to control the injector 205 based on the predicted foaming event.

The laboratory 201 includes a plurality of samples 209 that are used to provide laboratory data to the anti-foaming agent determination system 207. The plurality of samples 209 are extracted from different locations within the gas processing plant 100, including a sampling port for the sour gas feed 102 and lean amine solvent. The sample from the sour gas feed 102 may be used to conduct a gas composition analysis of the sour gas feed 102, including measuring for hydrogen sulfide, carbon dioxide, and hydrocarbons. High hydrogen sulfide and carbon dioxide levels in the sour gas feed 102 may lead to excessive acid gas loading in the amine solution and an increased viscosity, resulting in foaming. Heavy hydrocarbons in the sour gas feed 102 may reduce the dew point of the gas leading to gas condensation which may reduce amine surface tension and stabilize the foam. The sample from the lean amine solvent may be used to conduct an amine laboratory analysis of the amine solution including amine strength, acid gas loading, and total suspended solids (TSS). The measurements include key parameters related to the performance of the amine solution, such as rich and lean amine acid gas loadings (indicating the amount of hydrogen sulfide and carbon dioxide absorbed or stripped), active amine concentrations, pH, and levels of degradation products or contaminants like heat-stable salts. The amine concentration is critical, as low amine concentrations reduce absorption efficiency while high amine concentrations may increase viscosity and foaming. The pH measurements may indicate amine degradation or excessive acid gas absorption, which may lead to foaming. Potential degradation products include organic compounds such as urea, morpholine, oxazolidinones, and amides, which may act as surfactants and stabilize foam, reducing process efficiency. Heat-stable salts may increase solution viscosity and surface tension, stabilizing foam. This analysis prevents reduced acid gas removal efficiency and foaming.

In one or more embodiments, multiple sampling ports may be placed throughout the system to allow for samples from various sources ensuring optimal process control. For example, sampling ports for the sour gas feed may be located upstream where the sour gas originates or in the sour gas feed to the absorber inlet. These two locations allow for representative samples of the sour gas throughout the system. Additionally, sampling ports for the amine analysis may be located in both the lean amine solvent line 126 feeding to the absorber 104 and/or the heated rich amine solvent 136 to measure and analyze rich amine loading.

In one or more embodiments, advanced online analyzers and specialized sensors, such as refractometers, conductivity sensors, and total organic carbon (TOC) analyzers may be used. These lean amine analysis sensors (not shown) may be located at critical points along the amine circulation loop, such as the lean amine solvent 126, to evaluate performance of the lean amine solvent.

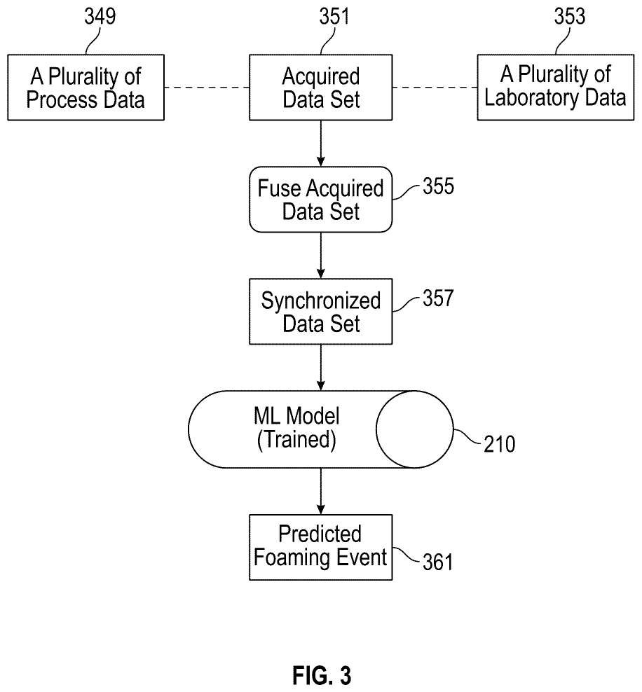

Turning to FIG. 3, a block diagram depicts, at a high-level, the determination of the predicted foaming event using the anti-foaming agent determination system 207. In particular, FIG. 3 depicts the acquisition and flow of process data and laboratory data, the fusing of these datasets, and the use of the ML model 210 to output a predicted foaming event or foaming event prediction. The plurality of process data 349 and the plurality of laboratory data 353 are acquired forming an acquired data set 351. As described below, the plurality of laboratory data 353 and the plurality of process data 349, jointly referred to herein as acquired data 351, are fused together. However, prior to fusing the acquired data, the acquired data may be processed (not shown) to remove noise and bias from the plurality of process data 349 and the plurality of laboratory data 353. One with ordinary skill in the art will recognize that other processing techniques may be applied without departing from the scope of this disclosure. In one or more embodiments, processing is omitted, and the acquired data is fused without prior alteration.

The plurality of process data 349 is collected at a process sampling frequency and the plurality of laboratory data 353 is collected at a laboratory sampling frequency. That is, the plurality of process data 349 can be considered a time series where various measurements, acquired using the plurality of sensors, are obtained with a temporal spacing or periodicity defined or described by the process sampling frequency. In some implementations, the sampling process sampling frequency need not be constant with time. That is, process data can be acquired at non-uniform time intervals. In this case, the process sampling frequency can refer to a time array for the process data, where the elements of the time array represent the time at which one or more associated measurements were obtained. For simplicity, the term process sampling frequency is used herein even in instances where the process data is not obtained according to a set frequency (i.e., the process sampling frequency can be an array of timestamps). Similarly, the plurality of laboratory data 353 can be represented as a time series where the time at which the physical samples are collected is known. Information regarding the time at which physical samples are collected is referenced herein as the laboratory sampling frequency. Similar to the process sampling frequency, the laboratory sampling frequency may be represented as a single number (e.g., a frequency, a period) when the intervals between collected physical samples is constant or as an array of timestamps when the physical samples are not collected according to a periodic schedule. The process data 349 and the laboratory data 353 are fused, or combined, before being processed by the ML model 210. In one or more embodiments, the process sampling frequency and the laboratory sampling frequency are different (e.g., not temporally aligned, acquired according to different periods, etc.) In one or more embodiments, the process sampling frequency is higher than the laboratory sampling frequency meaning that an interval between the collection of physical samples contains one or more instances of process data.

The acquired data set is fused 355, producing a synchronized data set 357. During data fusion, two different methods may be used to account for the different sampling frequency between the process data and the laboratory data. These methods are described assuming the process sampling frequency is higher than the laboratory sampling frequency, however, the reverse may be true. In one or more embodiments, linear interpolation is used to provide additional, estimated data points to the plurality of laboratory data 353 to achieve a sampling frequency equivalent to that of the plurality of process data 349. In other embodiments, intervals of data points of the plurality of process data are aggregated to effectively reduce the process sampling frequency to that of the laboratory sampling frequency. Aggregation can include the use of statistical features such as, but not limited to, mean, median, and maximum and minimum to combine data points. Through one or both of these two methods, the frequency of the process data and the laboratory data are made the same. That is, fusing the acquired data set 355 consists of applying one or more of interpolation and aggregation to one or more of the plurality of process data 349 and the plurality of laboratory data 353 such that these pluralities of data are temporally aligned and “filled” (i.e., no missing values for a given time or timestamp). The result of fusing the plurality of process data 349 and the plurality of laboratory data (353) is a synchronized data set 357 at a synchronized sampling frequency (e.g., an array of timestamps where there is a process data point and laboratory data point at each timestamp). In one or more embodiments, the synchronized sampling frequency is equivalent to the process sampling frequency.

The synchronized data set 357 is processed by the ML model 210 to produce a predicted foaming event 361. The ML model 210 may include, but is not limited to, a Vector AutoRegressive (VAR), Long Short-Term Memory (LSTM), Recurrent Neural Network (RNN), or Time Series Transformer.

In one or more embodiments, the synchronized data set (357) is temporally windowed (or otherwise truncated) before processing by the ML model (210). For example, only the most recent n data points in the synchronized data set (357) may be considered or processed by the ML model (210), where n≥1. In some embodiments, the windowing is performed by the ML model (210) itself. The width or size of the temporal window, or the number of data points that it encloses, can be a hyperparameter of the ML model (210) learned during training of the ML model (210), described below. In some embodiments, the ML model (210) is configured to accept a synchronized data set (210) of varying size such that windowing (e.g., to process the n most recent data points) is not necessary (e.g., all available data points are processed). In accordance with one or more embodiments, regardless of the window size, if any, the ML model (210) receives and processes synchronized data (357) representative of a point or interval in time and predicts a foaming event (i.e., predicted foaming event (361)) at a future time. For example, using t to index data points of the synchronized data set (357), where t is the current or most recent data point, the ML model (210) can operate as a function ƒ where a predicted foaming event at (t+1) is the output of ƒ(synchronized data [t, t−1, . . . , t−(n−1)]) and n indicates the number of data points considered in a temporal window.

In some embodiments, the ML model 210 predicts one or more of an occurrence of foaming and a severity of foaming at a future time. For example, the ML model 210 can predict a severity of foaming according to a predefined range such as 0 to 100 where 0 indicates no foaming and 100 indicates foaming that if realized, or allowed to be realized, would necessitate a shutting down of the gas processing plant. In this example, a returned value of 0 can also represent that there is no occurrence of foaming. In other embodiments, the ML model 210 predicts process data and laboratory data at one or more future times. Then, the predicted process data and laboratory data are evaluated to determine if they are associated with a foaming event, where again the foaming event can be given as one or more of an occurrence and a severity. For example, the predicted process data and the predicted laboratory data can be compared to one or more predefined thresholds, where violation of a threshold is indicative of a foaming event.

Because embodiments disclosed herein make use of a ML model (i.e., ML model 210), a brief introduction to machine learning (ML) is provided herein. However, one will recognize that while a full discussion of the field of ML is beyond the scope of this disclosure, this should not present a limitation on the use of ML or the ML model 210 in embodiments disclosed herein. Machine learning (ML), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, is adopted herein. However, one skilled in the art will recognize that the concepts and methods detailed hereafter are not limited by this choice of nomenclature. Machine learning model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength.

Commonly, in the literature, the selection of hyperparameters surrounding a machine learning model is referred to as selecting the model “architecture.” Once a machine learning model type and hyperparameters have been selected, the machine learning model is trained to perform a task. In accordance with one or more embodiments, a machine learning model type and associated architecture are selected, and the machine learning model is trained to predict a foaming event occurring within the gas processing plant 100. Once trained, the performance of the machine learning model may be evaluated (e.g., using a partition of training data not seen during training known as a “hold-out set” or “validation set” (or sometimes a “test set”)) and then used in a production setting (also known as deployment of the machine learning models), where the production setting indicates the use of the machine learning model.

The trained machine learning model 210 outputs a predicted foaming event 361, that is used, as described above, to determine one or more of an occurrence and severity of a foaming event in the future (i.e., at a time later or after the time(s) associated with the input data to the ML model). The predictions initiate using the injector 205 to inject an anti-foaming agent at the appropriate time and flow rate to prevent the potential, impending foaming event from impacting the gas processing plant 100.

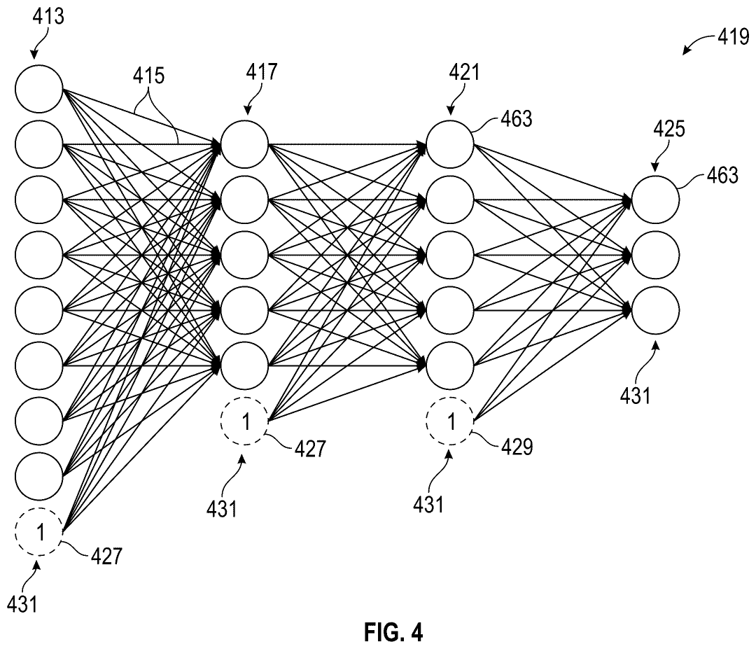

A diagram of a neural network is shown in FIG. 4. At a high level, a neural network (419) may be graphically depicted as being composed of nodes (463), where here any circle represents a node, and edges (415), shown here as directed lines. The nodes (463) may be grouped to form layers (431). FIG. 3 displays four layers (413, 417, 421, 425) of nodes (463) where the nodes (463) are grouped into columns, however, the grouping need not be as shown in FIG. 4. The edges (415) connect the nodes (463). Edges (415) may connect, or not connect, to any node(s) (463) regardless of which layer (431) the node(s) (463) is in. That is, the nodes (463) may be sparsely and residually connected. A neural network (419) will have at least two layers (431), where the first layer (413) is considered the “input layer” and the last layer (425) is the “output layer.” Any intermediate layer (417, 421) is usually described as a “hidden layer.” A neural network (419) may have zero or more hidden layers (417, 421) and a neural network (419) with at least one hidden layer (417, 421) may be described as a “deep” neural network or as a “deep learning method.” In general, a neural network (419) may have more than one node (463) in the output layer (425). In this case the neural network (419) may be referred to as a “multi-target” or “multi-output” network.

Nodes (463) and edges (415) carry additional associations. Namely, every edge is associated with a numerical value. The edge numerical values, or even the edges (415) themselves, are often referred to as “weights” or “parameters”. While training a neural network (419), numerical values are assigned to each edge (415). Additionally, every node (463) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) \qquad EQ 1$$

where i is an index that spans the set of “incoming” nodes (463) and edges (415) and ƒ is a user-defined function. Incoming nodes (463) are those that, when viewed as a graph (as in FIG. 3), have directed arrows that point to the node (463) where the numerical value is being computed. Some functions for ƒ may include the linear function ƒ(x)=x, sigmoid function

$$f ( x ) = \frac{1}{1 + {e}^{- x}}$$

and rectified linear unit function ƒ(x)=max (0, x), however, many additional functions are commonly employed. Every node (463) in a neural network (419) may have a different associated activation function. Often, as a shorthand, activation functions are described by the function ƒ by which it is composed. That is, an activation function composed of a linear function ƒ may simply be referred to as a linear activation function without undue ambiguity.

When the neural network (419) receives an input, the input is propagated through the network according to the activation functions and incoming node (463) values and edge (415) values to compute a value for each node (463). That is, the numerical value for each node (463) may change for each received input. Occasionally, nodes (463) are assigned fixed numerical values, such as the value of 1, that are not affected by the input or altered according to edge (415) values and activation functions. Fixed nodes (463) are often referred to as “biases” or “bias nodes” (306), displayed in FIG. 3 with a dashed circle.

In some implementations, the neural network (419) may contain specialized layers (431), such as a normalization layer, or additional connection procedures, like concatenation. One skilled in the art will appreciate that these alterations do not exceed the scope of this disclosure.

As noted, the training procedure for the neural network (419) comprises assigning values to the edges (415). To begin training the edges (415) are assigned initial values. These values may be assigned randomly, assigned according to a prescribed distribution, assigned manually, or by some other assignment mechanism. Once edge (415) values have been initialized, the neural network (419) may act as a function, such that it may receive inputs and produce an output. As such, at least one input is propagated through the neural network (419) to produce an output. Training data is provided to the neural network (419). Generally, training data consists of pairs of inputs and associated targets. The targets represent the “ground truth,” or the otherwise desired output, upon processing the inputs. In the context of the instant disclosure, an input is a temporal window of synchronized data (i.e., a temporal window of fused process data and laboratory data having the same sampling frequency) and its associated target is a given foaming event (e.g., a user-given or user-labelled severity of foaming at a future time). The targets can originate from observed foaming events of the gas processing plant or other gas processing plants. That is, input-target pairs using for training can be extracted from historical data of a gas processing plant, the historical data including process data, laboratory data, and a foaming event.

During training, the neural network (419) processes at least one input from the training data and produces at least one output. Each neural network (419) output is compared to its associated input data target. The comparison of the neural network (419) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (419) output and the associated target. The loss function may also be constructed to impose additional constraints on the values assumed by the edges (415), for example, by adding a penalty term, which may be physics-based, or a regularization term (not be confused with regularization of seismic data). Generally, the goal of a training procedure is to alter the edge (415) values to promote similarity between the neural network (419) output and associated target over the training data. Thus, the loss function is used to guide changes made to the edge (415) values, typically through a process called “backpropagation.”

While a full review of the backpropagation process exceeds the scope of this disclosure, a brief summary is provided. Backpropagation consists of computing the gradient of the loss function over the edge (415) values. The gradient indicates the direction of change in the edge (415) values that results in the greatest change to the loss function. Because the gradient is local to the current edge (415) values, the edge (415) values are typically updated by a “step” in the direction indicated by the gradient. The step size is often referred to as the “learning rate” and need not remain fixed during the training process. Additionally, the step size and direction may be informed by previously seen edge (415) values or previously computed gradients. Such methods for determining the step direction are usually referred to as “momentum” based methods.

Once the edge (415) values have been updated, or altered from their initial values, through a backpropagation step, the neural network (419) will likely produce different outputs. Thus, the procedure of propagating at least one input through the neural network (419), comparing the neural network (419) output with the associated target with a loss function, computing the gradient of the loss function with respect to the edge (415) values, and updating the edge (415) values with a step guided by the gradient, is repeated until a termination criterion is reached. Common termination criteria are: reaching a fixed number of edge (415) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (415) values are no longer intended to be altered, the neural network (419) is said to be “trained.”

In accordance with one or more embodiments, the ML model (210) is trained using a historical dataset including process data, laboratory data, and foaming events. The historical data can be pre-processed and undergo a fusing process as described above to form input-target pairs of temporally windowed synchronized data and foaming events used to train the ML model (210). In one or more embodiments, the method used for fusing the process data and laboratory data (i.e., interpolation, aggregation, or a combination thereof) is a hyperparameter of the ML model (210). Further, in one or more embodiments, the width of the temporal window is also a hyperparameter of the ML model (210). These hyperparameters, and others (e.g., size of a latent vector in a recurrent neural network such an LSTM), can be selected by a user or learned during the training process (e.g., selecting the hyperparameters that optimize the performance of the trained ML model on a validation set).

As stated, the ML model (210) is trained using a historical dataset including process data, laboratory data, and foaming events. In one or more embodiments, the training data is created by labelling or annotating one or more of the occurrence and severity of a foaming event by experienced process engineers. In some implementations, the occurrence of a foaming event is determined by comparing the severity, or other quantitative measure of a foaming event, to one or more thresholds marking the onset of foaming events. The one or more identified thresholds are selected or otherwise informed by process engineers coupled with thorough analysis of operational data and historical trends. For example, foaming events that exceed these identified thresholds are identified as suspected foaming incidents, allowing for an initial threshold-based labeling. Then, process engineers validate the identified suspected foaming events against operational logs and expert experience to label or annotate the foaming event in the historical data. By cross-validating suspected events with operational logs and leveraging expert insights, the training dataset is enhanced by increasing the likelihood that true and actual foaming events are used in training the ML model (210) such that the ML model (210) can accurately distinguish or predict actual foaming events from other exceptional events and fluctuations caused by other factors. In one or more embodiments, the process data, laboratory data, and foaming events are pre-processed, fused, and partitioned (e.g., according to temporal window) to form the training dataset including input-target pairs of temporally windowed synchronized data and foaming events.

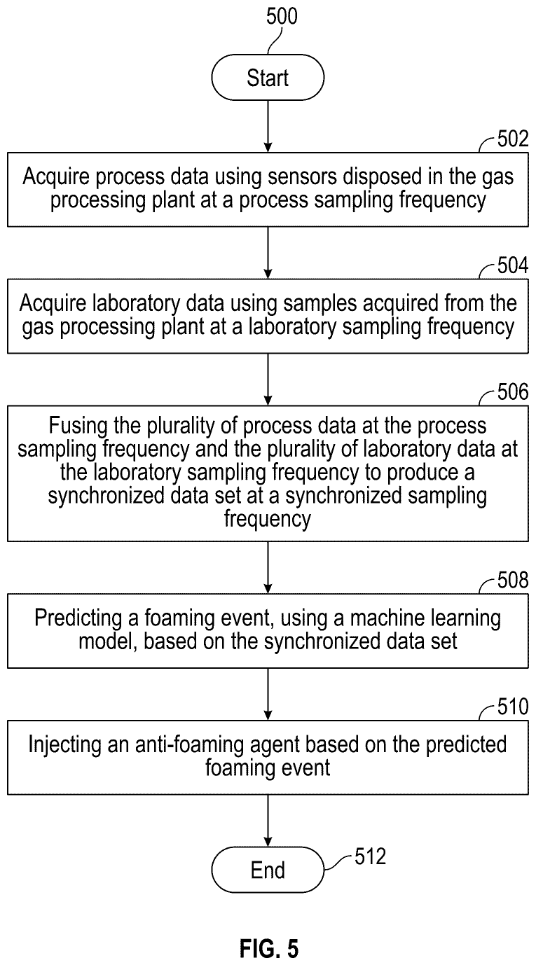

FIG. 5 is a flow chart of the method for predicting foaming in a gas processing plant. In step 502, process data is acquired using sensors disposed in the gas processing plant at a process sampling frequency. In step 504, laboratory data is acquired using samples acquired from the gas processing plant at a laboratory sampling frequency. As discussed above, though not explicitly illustrated in FIG. 5, an intermediate processing step may occur to remove noise and bias from the process data and the laboratory data to produce clean process data and clean laboratory data. In step 506, the process data at the process sampling frequency and the laboratory data at the laboratory sampling frequency is fused to produce a synchronized data set at a synchronized sampling frequency. As discussed in greater detail above, data fusion may occur through different methods including interpolation and/or aggregation to achieve the synchronized data set at the synchronized sampling frequency. In step 508, a trained machine learning model predicts a foaming event based on the synchronized data set. When a foaming event is predicted, the method proceeds to step 510, where an anti-foaming agent is injected. The trained machine learning model may predict a quantified severity value for the impending foaming event in addition to its presence. The severity may closely correlate to the required anti-foaming agent flow rate and injection time duration. The flow rate and injection time duration may be controlled by the anti-foaming agent determination system 207 that was discussed above. Thus, the systems and methods described herein allow for real-time and automatic response to, or preemption of, foaming events by controlling the injection of an anti-foaming agent based on determined synchronized data, where the synchronized data is processed in real-time as available from the gas processing plant and laboratory.

The severity value may be based on several metrics including various operational and process parameters. In one or more embodiments, the severity value is a scaled value (for example, a value between 1 and 10) to quantify foaming based on foam volume/height, gas sweetening efficiency, flash tank pressure, carryover, and contactor (absorber or regenerator) level fluctuation. Regarding foam volume/height, the physical volume or height of the foam generated may be measured using differential pressure sensors, where the magnitude of the differential pressure relates to the volume and height of the foam itself. A noticeable drop in gas sweetening efficiency may indicate severe foaming and can be incorporated into the severity value. An increase in flash tank 116 pressure and quantity of flash gas 112 indicate hydrocarbon entrainment in the rich amine which may indicate higher levels of foaming. Carryover can result from gas foaming, where liquid or foam escapes into downstream equipment, thus carryover may be considered both a symptom and a consequence of foaming. The contactor level fluctuation may indicate foaming as the level will fluctuate when foaming occurs. These factors in conjunction may be utilized to quantify the severity value.

Though not explicitly shown in FIG. 5, key performance indicators may be displayed related to the predicted foaming event on a human machine interface. Key performance indicators include flow rates, differential pressures, temperatures, liquid level fluctuations, energy levels, and measurements from filter coalescers throughout the system. For example, the severity value may be provided on the human machine interface. The human machine interface may also display visual or auditory alarms based on the predicted foaming event. The key performance indicators are derived from critical operational parameters that are directly tied to process performance and foaming risk management. The key performance indicators are designed through close collaboration with process engineers and operators to ensure they reflect real-world operational priorities. In one or more embodiments, the key performance indicators are dynamically integrated into or otherwise displayed using the human machine interface allowing operators to view real-time key performance indicator trends and predictive insights. Further, in some embodiments, visualization of the key performance indicators is enhanced with clear indicators (e.g., green, yellow, and/or red zones) to signal process health and alert operators. Further, in some embodiments, one or more of the key performance indicators are used as inputs to the ML model (210), alongside the synchronized data set. That is, key performance indicators can be synchronized with and appended to the plurality of process data (349) and the plurality of laboratory data (353). The use of one or more key performance indicators with the ML model (210) serves to refine the predictive capabilities of the ML model (210) enhancing its accuracy over time. Visual alarms may be in the form of flashing lights, text, or specified colors indicating that a foaming event is predicted. Additionally, flow rates of sour gas or lean amine, temperatures, and/or pressures may be adjusted to stabilize conditions and reduce foam generation.

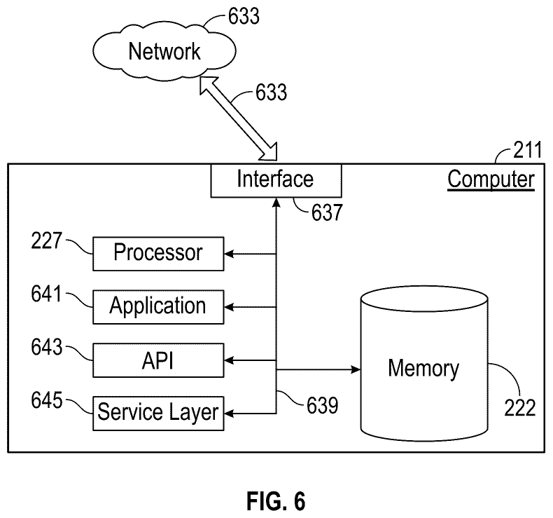

FIG. 6 depicts a block diagram of a computer system (211) used to provide computational functionalities associated with described algorithms, methods, functions, processes, flows, and procedures as described in this disclosure, according to one or more embodiments. The illustrated computer (211) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (211) may include a computer that includes an input device, such as a keypad, keyboard, touch screen, or other device that can accept user information, and an output device that conveys information associated with the operation of the computer (211), including digital data, visual, or audio information (or a combination of information), or a GUI.

The computer (211) can serve in a role as a client, network component, a server, a database or other persistency, or any other component (or a combination of roles) of a computer system for performing the subject matter described in the instant disclosure. In some implementations, one or more components of the computer (211) may be configured to operate within environments, including cloud-computing-based, local, global, or other environment (or a combination of environments).

At a high level, the computer (211) is an electronic computing device operable to receive, transmit, process, store, or manage data and information associated with the described subject matter. According to some implementations, the computer (211) may also include or be communicably coupled with an application server, e-mail server, web server, caching server, streaming data server, business intelligence (BI) server, or other server (or a combination of servers).

The computer (211) can receive requests over network (633) from a client application (for example, executing on another computer (211) and responding to the received requests by processing the said requests in an appropriate software application. In addition, requests may also be sent to the computer (211) from internal users (for example, from a command console or by other appropriate access method), external or third-parties, other automated applications, as well as any other appropriate entities, individuals, systems, or computers.

Each of the components of the computer (211) can communicate using a system bus (639). In some implementations, any or all of the components of the computer (211), both hardware or software (or a combination of hardware and software), may interface with each other or the interface (637) (or a combination of both) over the system bus (639) using an application programming interface (API) (643) or a service layer (645) (or a combination of the API (643) and service layer (645). The API (643) may include specifications for routines, data structures, and object classes. The API (643) may be either computer-language independent or dependent and refer to a complete interface, a single function, or even a set of APIs. The service layer (645) provides software services to the computer (211) or other components (whether or not illustrated) that are communicably coupled to the computer (211). The functionality of the computer (211) may be accessible for all service consumers using this service layer. Software services, such as those provided by the service layer (645), provide reusable, defined business functionalities through a defined interface. For example, the interface may be software written in JAVA, C++, or other suitable language providing data in extensible markup language (XML) format or another suitable format. While illustrated as an integrated component of the computer (211), alternative implementations may illustrate the API (643) or the service layer (645) as stand-alone components in relation to other components of the computer (211) or other components (whether or not illustrated) that are communicably coupled to the computer (211). Moreover, any or all parts of the API (643) or the service layer (645) may be implemented as child or sub-modules of another software module, enterprise application, or hardware module without departing from the scope of this disclosure.

The computer (211) includes an interface (637). Although illustrated as a single interface (637) in FIG. 10, two or more interfaces (1004) may be used according to particular needs, desires, or particular implementations of the computer (211). The interface (637) is used by the computer (211) for communicating with other systems in a distributed environment that are connected to the network (633). Generally, the interface (637) includes logic encoded in software or hardware (or a combination of software and hardware) and operable to communicate with the network (633). More specifically, the interface (637) may include software supporting one or more communication protocols associated with communications such that the network (633) or interface's hardware is operable to communicate physical signals within and outside of the illustrated computer (211).

The computer (211) includes at least one computer processor (641). Although illustrated as a single computer processor (641) in FIG. 10, two or more processors may be used according to particular needs, desires, or particular implementations of the computer (211). Generally, the computer processor (641) executes instructions and manipulates data to perform the operations of the computer (211) and any algorithms, methods, functions, processes, flows, and procedures as described in the instant disclosure.

The computer (211) also includes a memory (222) that holds data for the computer (211) or other components (or a combination of both) that can be connected to the network (633). The memory may be a non-transitory computer readable medium. For example, memory (222) can be a database storing data consistent with this disclosure. Although illustrated as a single memory (222) in FIG. 10, two or more memories may be used according to particular needs, desires, or particular implementations of the computer (211) and the described functionality. While memory (222) is illustrated as an integral component of the computer (211), in alternative implementations, memory (222) can be external to the computer (211).

The application (641) is an algorithmic software engine providing functionality according to particular needs, desires, or particular implementations of the computer (211), particularly with respect to functionality described in this disclosure. For example, application (641) can serve as one or more components, modules, applications, etc. Further, although illustrated as a single application (641), the application (641) may be implemented as multiple applications (641) on the computer (211). In addition, although illustrated as integral to the computer (211), in alternative implementations, the application (641) can be external to the computer (211).

There may be any number of computers (211) associated with, or external to, a computer system containing computer (211), wherein each computer (211) communicates over network (633). Further, the term “client,” “user,” and other appropriate terminology may be used interchangeably as appropriate without departing from the scope of this disclosure. Moreover, this disclosure contemplates that many users may use one computer (211), or that one user may use multiple computers (211).

Embodiments of the present disclosure may provide at least one of the following advantages. Early predictions of impending foaming events will allow for proactive management and early intervention of foaming events, ensuring that the gas processing plant operates with optimal efficiency. The system and method will allow for process operations personnel to continuously monitor and assess the process throughout normal operating procedures.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for predicting foaming in a gas processing plant, comprising:
acquiring a plurality of process data, using a plurality of sensors disposed in the gas processing plant, at a process sampling frequency;
acquiring a plurality of laboratory data using a plurality of samples acquired from the gas processing plant at a laboratory sampling frequency;
fusing the plurality of process data at the process sampling frequency and the plurality of laboratory data at the laboratory sampling frequency to produce a synchronized data set at a synchronized sampling frequency;
predicting a foaming event, using a machine learning model, based on the synchronized data set; and
injecting an anti-foaming agent in the gas processing plant based on the predicted foaming event.

2. The method of claim 1, further comprising:
processing the plurality of process data and the plurality of laboratory data to produce a plurality of clean process data at the process sampling frequency and a plurality of clean laboratory data at the laboratory sampling frequency, wherein the clean process data and the plurality of clean laboratory data are fused to produce the synchronized data set.

3. The method of claim 2, wherein processing the plurality of process data and the plurality of laboratory data to produce the plurality of clean process data and the plurality of clean laboratory data comprises removing noise and bias from the plurality of process data and the plurality of laboratory data.

4. The method of claim 1, wherein:
the process sampling frequency is higher than the laboratory sampling frequency;
the synchronized sampling frequency is equal to the process sampling frequency; and
fusing the plurality of process data at the process sampling frequency and the plurality of laboratory data at the laboratory sampling frequency comprises interpolating the plurality of clean laboratory data to have the process sampling frequency.

5. The method of claim 1, wherein:
the process sampling frequency is higher than the laboratory sampling frequency;
the synchronized sampling frequency is equal to the process sampling frequency; and
fusing the plurality of process data at the process sampling frequency and the plurality of laboratory data at the laboratory sampling frequency comprises aggregating the plurality of clean laboratory data to have the process sampling frequency.

6. The method of claim 1, wherein the machine learning model is selected from the group consisting of Vector AutoRegressive (VAR), Long Short-Term Memory (LSTM), Recurrent Neural Networks (RNN), and Time Series Transformers.

7. The method of claim 1, further comprising:
displaying a plurality of key performance indicators related to the foaming event on a human machine interface; and
triggering an alarm related to the foaming event on the human machine interface.

8. The method of claim 1, wherein acquiring the plurality of process data using the plurality of sensors further comprises:
receiving an absorber differential pressure from an absorber pressure sensor;
receiving a sour gas flow rate from a sour gas flow sensor;
receiving a sour gas feed pressure from a sour gas feed pressure sensor;
receiving a sour gas feed temperature from a sour gas feed temperature sensor;
receiving a sour gas feed composition from a sour gas feed composition sensor;
receiving an absorber liquid level from an absorber liquid level sensor; and
receiving one or more temperature values from one or more temperature sensors.

9. The method of claim 1, wherein acquiring the plurality of laboratory data further comprises:
conducting a gas composition analysis of a sour gas feed; and
conducting an amine laboratory analysis of an amine solution.

10. The method of claim 1, wherein:
the predicted foaming event comprises a severity of the foaming event,
injecting the anti-foaming agent comprises controlling an anti-foaming agent flow rate and an anti-foaming agent time duration based on the severity.

11. A system for predicting foaming in gas processing plants, comprising:
a gas processing plant, comprising:
an absorber configured to receive a sour gas feed and a lean solvent and produce a rich solvent and a sweet gas;
a regenerator configured to receive the rich solvent and produce the lean solvent to circulate back to the absorber for continual processing; and
a plurality of sensors disposed on the gas processing plant;
a computer comprising one or more computer processors and communicably coupled to the plurality of sensors, the computer configured to:
acquire a plurality of process data at a process sampling frequency from the plurality of sensors;
acquire a plurality of laboratory data using samples acquired from the gas processing plant at a laboratory sampling frequency;
fuse the plurality of process data at the process sampling frequency and the plurality of laboratory data at the laboratory sampling frequency to produce a synchronized data set at a synchronized sampling frequency;
determine a foaming event, using a machine learning model, based on the synchronized data set; and
transmit a signal to inject an anti-foaming agent based on the foaming event.

12. The system of claim 11, wherein the plurality of sensors comprises:
a temperature sensor;
a sour gas feed sensor; and
an absorber sensor.

13. The system of claim 12, wherein the sour gas feed sensor comprises:
a sour gas flow sensor that measures a sour gas flow rate comprised by the plurality of process data;
a sour gas feed pressure sensor that measures a sour gas feed pressure comprised by the plurality of process data;
a sour gas feed temperature sensor that measures a sour gas feed temperature comprised by the plurality of process data; and
a sour gas feed composition sensor that measures a sour gas feed composition comprised by the plurality of process data.

14. The system of claim 12, wherein the absorber sensor comprises:
an absorber pressure sensor that measures an absorber differential pressure comprised by the plurality of process data; and
an absorber liquid level sensor that measures an absorber liquid level comprised by the plurality of process data.

15. The system of claim 11, wherein the machine learning model is selected from the group consisting of Vector AutoRegressive (VAR), Long Short-Term Memory (LSTM), Recurrent Neural Networks (RNN), and Time Series Transformers.

16. The system of claim 11, further comprising an anti-foaming agent injector that is caused to inject the anti-foaming agent in response to receiving the signal.

17. The system of claim 11, wherein:
the determined foaming event comprises a severity of the foaming event,
the signal to inject the anti-foaming agent indicates an anti-foaming agent flow rate and an anti-foaming agent time duration based on the severity.

18. A non-transitory computer-readable memory comprising computer-executable instructions stored thereon that, when executed on a processor, cause the processor to perform steps comprising:
acquiring a plurality of process data at a process sampling frequency from a plurality of sensors disposed on a gas processing plant;
acquiring a plurality of laboratory data using samples acquired from the gas processing plant at a laboratory sampling frequency;
fusing the plurality of process data at the process sampling frequency and the plurality of laboratory data at the laboratory sampling frequency to produce a synchronized data set at a synchronized sampling frequency;
determining, using a machine learning model, a foaming event, based on the synchronized data set; and
transmitting, to an anti-foaming agent injector, a signal to inject an anti-foaming agent based on the foaming event, wherein the anti-foaming agent injector is caused to inject the anti-foaming agent to the gas processing plant in response to receiving the signal.

19. The non-transitory computer-readable memory of claim 18, wherein:
the determined foaming event comprises a severity of the foaming event,
the signal to inject the anti-foaming agent indicates an anti-foaming agent flow rate and an anti-foaming agent time duration based on the severity.

20. The non-transitory computer-readable memory of claim 9, wherein the plurality of laboratory data comprises:
a gas composition analysis of a sour gas feed; and
an amine analysis of an amine solution,
wherein the gas composition analysis and amine analysis are conducted at a laboratory.
